(19) United States
(12) Patent Application Publication
(10) Pub. No.: US 2025/0377373 A1
(43) Pub. Date: Dec. 11, 2025

(54) TRANSFER DEVICE, TRANSFER SYSTEM AND PIPETTING SYSTEM

(71) Applicant: Analytik Jena GmbH+Co. KG, Jena (DE)

(72) Inventors: Torsten Schöppe, Jena (DE); Sebastian Purmann, Göttingen (DE); Jan Kaiser, Stollberg (DE)

(21) Appl. No.: 19/232,187

(22) Filed: Jun. 9, 2025

(30) Foreign Application Priority Data
Jun. 10, 2024 (DE) 10 2024 116 189.2

(51) Int. Cl. G01N 35/10

(52) U.S. Cl. CPC G01N 35/1074; G01N 2035/103

(57) ABSTRACT

A transfer device for inserting a pipette carrier into a pipetting apparatus that includes a comb structure having an elongated base and a plurality of teeth arranged perpendicularly thereto, wherein the teeth are arranged parallel and equidistantly relative to one another and comprise two outer teeth and a plurality of inner teeth arranged between the outer teeth, wherein the elongated base and the two outer teeth are embodied in the form of a three sided frame, wherein at least one inner tooth has a length greater than at least one other inner tooth.

The present application is related to and claims the priority benefit of German Patent Application No. 10 2024 116 189.2, filed on Jun. 10, 2024, the entire contents of which are incorporated herein by reference.

### TECHNICAL FIELD

The present disclosure relates to a transfer device for introducing a pipette carrier populated with pipette tips into an automatic pipetting machine, a transfer system comprising a transfer device and a pipette carrier, and a pipetting system comprising a transfer system and an automatic pipetting machine. The pipette tips have a distal end region and a proximal end region having a collar.

### BACKGROUND

Repetitive tasks in the laboratory are increasingly being taken over by automated laboratory devices. For example, for biochemical analyses in the fields of chemistry and pharmacy, systems are desired for automated handling of liquid samples. Thus, so-called liquid handling systems serve for preparing samples and/or for analysis of the prepared samples. Such laboratory devices are also known under terms such as pipetting robot and pipetting- and analysis device. Tasks performed by these pipetting apparatuses include, among others, the supply and removal of defined volumes of liquids into and from laboratory elements, in order, for example, by supplying a reagent, to initiate a biochemical reaction, as well as the preparing of samples for subsequent measuring in an analytical device, such as, for example, preparation in the form of drying the samples. Analytical devices include all devices, which determine at least one chemical and/or physical feature of the sample, examples being devices for spectroscopy and spectrometry, as well as also pH- and conductivity probes, and other devices.

Corresponding automated pipetting apparatuses include at least one pipette, which may be arranged in, sometimes exchangeable, pipetting heads. Simple automated pipetting, or dosing, apparatuses issue only a defined amount of a liquid, while in larger automated pipetting apparatuses the pipetting heads are movable in two or three spatial directions. More complex automated pipetting apparatuses frequently undertake additional tasks, such as the transport and handling of laboratory elements, as well as the mixing and incubating of samples.

A pipette serves for taking in and releasing defined volumes of liquids. The pipette may be so embodied that the liquid does not reach the interior of the pipette. Instead, a pipette tip is placed on an end region of the pipette and the liquid is accommodated in the pipette tip. In the case of manual pipettes with only one pipetting channel, which controls the intake and release of a defined volume of a liquid into and from the pipette tip by applying an appropriate negative or positive pressure, the end region of the pipette may be conically or shaft shaped. The pipette tip is connected, in such case, with the end region of the pipette by force interlocking, e.g. frictional interlocking, and, in part, supplementally secured with a sealing element, for example, an O-ring.

Multi-channel pipetting apparatuses enable handling a plurality of volumes simultaneously. Instead of a single pipetting channel, these have several or many pipetting channels. Such a multi-channel pipetting apparatus is known from DE 20 2008 013 533 U1. In such case, it is possible simultaneously to move, for example, between 4 and 384 samples of a defined amount of liquid. The pipetting channels are provided in a base plate. As an alternative for mounting the pipette tips on a conical or shaft-like end region of the pipette in the case of multi-channel pipettes, frequently a sealing plate is applied, which has elastic properties. The pipette tips are pressed against the sealing plate with a defined force. The sealing plate terminates the base plate and like the base plate, leads the pipetting channels. The active pressing of the pipette tips against the sealing plate assures that, upon applying a negative pressure, a defined volume of liquid is drawn into the pipette tip and kept there, until the liquid is released. In the case of a plurality of utilized pipetting channels and the corresponding plurality of pipette tips, it is to be ensured that each pipette tip is sealed by means of the sealing plate.

The pipette tips are frequently provided in so-called magazines. The magazines are planar, rigid plates with passageways, in which the pipette tips are accommodated. Such a magazine, populated with pipette tips, is then moved in the direction of the sealing plate, so that the pipette tips are pressed against the sealing plate. Ideally, the longitudinal axes of the pipette tips are arranged, in such case, in parallel with the cross sectional plane of the sealing plate, in order to enable an optimal sealing of the pipette tips. Such a magazine is disclosed, for example, in DE 20 2020 100 836 U1.

The magazines are used only once and then disposed of, this meaning high material consumption- and costs.

### SUMMARY

An object of the present disclosure is, consequently, to provide a transfer device, a transfer system and a pipetting system, which save material compared with conventional solutions.

According to the present disclosure, the object is achieved by a transfer device, a transfer system, and a pipetting system.

Regarding the transfer device, the object is achieved according to the present disclosure by a transfer device for introducing a pipette carrier into a pipetting apparatus, comprising:
a comb structure having an elongated base and a plurality of teeth arranged perpendicularly thereto, wherein the teeth are arranged parallel and equidistantly relative to one another and comprise two outer teeth and a plurality of inner teeth arranged between the outer teeth, wherein the elongated base and the two outer teeth are embodied in the form of a three sided frame, wherein at least one inner tooth has a length greater than at least one other inner tooth.

The transfer device can be reused, while the pipette carrier, thus, for example, a single plate support or a double plate support, is only used once. Instead of disposing of a complete magazine, only the pipette carrier needs to be disposed of, while the transfer device can be reused. In this way, material and costs are saved. The transfer device can be manufactured by an injection molding method and be made, for example, of a plastic. The transfer device can also be made of a metal or metal alloy or comprise at least one metal. The transfer device can be embodied as a single piece. For example, the comb structure is connected with the frame and the holding element by continuous material. The inner teeth can be embodied to hold the pipette carrier.

By means of the at least one inner tooth with the greater length, introduction of the pipette carrier into the transfer device is facilitated, for example, the threading of the pipette carrier, and the pipette tips in the pipette carrier, between the inner teeth is facilitated.

In at least one embodiment, the inner teeth become progressively longer from the outer teeth to a middle of the comb structure.

In at least one additional embodiment, one or two inner teeth in the middle of the comb structure are shorter than the teeth surrounding them.

In a further development, one or two inner teeth are longer than the remaining inner teeth.

In an additional embodiment, the transfer device includes at least one holding element arranged on the frame and embodied in such a manner that the pipette carrier is lockable in the transfer device along at least one axis. The locking prevents a slipping of the pipette carrier in the transfer device, for example, during transport or during introduction of the transfer device into a pipetting apparatus. The holding element is oriented in the direction of the comb structure. The comb structure can have an upper side and a lower side. For example, the at least one holding element is arranged on the upper side.

In at least one embodiment, the at least one holding element is an eave, a recess, a projection and/or an indentation.

For example, the at least one holding element is embodied as a radial segment or circular segment.

In an alternative embodiment, the at least one holding element includes a spring, a magnet and/or a rotary element.

In a further development, the transfer device includes a handle arranged on the elongated base. The handle serves, for example, for holding the transfer device by means of an operator or a robot.

For example, the handle includes a centering element, for example, an opening, which is embodied in such a manner that the transfer device can be moved by automated means. For example, a robot can engage in the centering element, in order to hold and to transport the transfer device.

In at least one embodiment, the frame includes a frame depression located in the region of the elongated base and arranged centrally on the elongated base.

For example, the frame depression is embodied in such a manner that the frame is lowered by the frame depression to a height of the handle. For example, the frame depression extends essentially over the width of the handle. The frame depression can be matched to a grip or a grip element of the pipette carrier, of the single plate support or the double plate support. The frame depression can be embodied in such a manner that the grip or the grip element of the pipette carrier is introducible into the frame depression. An operator or a robots can, thus, grip the grip or the grip element in the frame depression and by an exertion of force in the direction of the lower side of the comb structure release a locking of the pipette carrier in the transfer device and so remove the pipette carrier from the transfer device.

In at least one embodiment, the frame includes at least two orienting elements, which are embodied in such a manner that the transfer device is introducible by automated means into the pipetting apparatus. The orienting elements serve for guiding the transfer device into the pipetting apparatus.

In a further development, the frame includes at least one peripheral guide groove. The at least one guide groove supports the insertion of a pipette carrier into the transfer device, in that the pipette carrier is guided in the guide groove. The at least one guide groove can be arranged on the upper side or the lower side of the comb structure. For example, the lower plate and/or the upper plate of a double plate support can engage in the at least one guide groove.

In at least one embodiment, the frame includes at least one stop surface, which is arranged at least along the elongated base, and which is arranged at the same height of the frame as the upper side of the inner teeth or which is arranged between the teeth. The stop surface, which is arranged at the same height of the frame as the upper side of the inner teeth, can extend around the frame. The stop surface serves for guiding the pipette carrier upon the introduction into the transfer device.

In at least one embodiment, the frame includes a gripping element, such as, for example, a ledge, an edge or a surface, by means of which a force is exertable on the transfer device, for example, in the direction of the upper side of the comb structure. The pipetting apparatus can, by means of the gripping element, exert force on the transfer device, in order to seal the pipette tips against a sealing plate.

The inner teeth may have at one of the elongated base ends an engagement element, for example, an edge or a ledge, by means of which a force is exertable on the transfer device. The ledge or edge serves for exerting a force on the transfer device, for example, by means of the pipetting apparatus. The force is exerted from a lower side of the comb structure in the direction of its upper side. The engagement element is important in connection with a single plate support, which has, no application point for exerting a force. A force for sealing the pipette tips in a single plate support in a pipetting apparatus occurs by means of the engagement element and the gripping element of the transfer device.

In an embodiment, the inner teeth have a tapered cross section tapering narrower in the direction of the upper side. The tapering tapered cross section serves for better force transmission from a pipetting apparatus to the transfer device. In this way, a force imposed from a lower side of the comb structure in the direction of the upper side of the comb structure can be advantageously transferred to the upper side of the comb structure, such that the collars of the pipette tips are reliably sealed against a sealing plate of the pipetting apparatus.

In at least one embodiment, the tapered cross section is made in such a manner that the tapered cross section and an outer diameter of the pipette tips are matched to one another over the entire height of the inner teeth. In this embodiment, the force loss upon force transfer from the pipetting apparatus to the transfer device is minimized.

In at least one additional embodiment, the inner teeth are reduced in height on the lower side in such a manner that a height of the inner teeth becomes progressively smaller from the elongated base to an elongated base far end of the inner teeth. By means of the reduction in height of the inner teeth, a geometry optimization of the transfer device is possible when the pipette carrier is introduced into the transfer device. For example, errors in the manufacturing tolerances of the pipette carrier are compensated by means of the reduction in height.

In at least one embodiment, the inner teeth are reduced in height on the lower side in such a manner that, upon a force applied on the inner teeth, the inner teeth are, at most, so deformed that the lower side of the inner teeth approximates or reaches a horizontal position.

In at least one additional embodiment, the inner teeth are reduced in height in such a manner that the height of the inner teeth reduces at an angle between 0.05° and 3°.

Regarding the transfer system, the object is achieved according to the present disclosure by a transfer system comprising
a pipette carrier, for example, a double plate support or a single plate support, and
a transfer device according to one of the preceding embodiments,
wherein the pipette carrier is introducible into the transfer device.

The pipette carrier includes at least one plate having a plurality of passageways or openings for holding pipette tips. The passageways or openings can be embodied to hold the pipette tips. The pipette carrier can be embodied as a double plate support or a single plate support. The pipette carrier can be introduced into the transfer device. The pipette carrier can be introduced into the transfer device by means of the inner teeth. For example, the inner teeth are guided between the pipette tips in the pipette carrier. The pipette carrier can be introduced into the transfer device by means of the inner teeth. The inner teeth are guided between the pipette tips in the pipette carrier. The transfer system can comprise a plurality of pipette tips, which are introduced into the pipette carrier. Optionally, the transfer system can comprise, besides the transfer device, a support system or a support arrangement.

An embodiment provides that the pipette carrier is a double plate support and a distance between the struts is embodied in such a manner that the transfer device can by means of the inner teeth engage between the struts and hold the double plate support.

An alternative embodiment provides that the pipette carrier is a single plate support and a distance between the orienting elements is embodied in such a manner that the transfer device can by means of the inner teeth engage between the orienting elements and hold the single plate support.

In a further development, the transfer device includes at least one holding element and the pipette carrier includes at least one locking element, which is embodied corresponding to the holding element,
wherein the pipette carrier is introducible into the transfer device and lockable in the transfer device by means of the at least one locking element and the at least one holding element. The at least one locking element can be attached to the plate. The pipette carrier can be embodied as a double plate support or a single plate support. The at least one holding element and the at least one locking element can be embodied in such a manner that a locking of the pipette carrier and the transfer device is achieved by means of a shape interlocking or a pin-based engagement.

As regards the pipetting system, the object is achieved according to the present disclosure by a pipetting system comprising:
a transfer system according to one of the preceding embodiments, and
a pipetting apparatus having a pipetting head with a sealing plate and a plurality of pipetting channels for the suctioning and issuing of liquids into and from the pipette tips, wherein the pipetting channels are led through the sealing plate,
wherein the transfer system is introducible into the pipetting apparatus, and wherein the pipetting apparatus is adapted to exert a force on the transfer device in such a manner that the pipette tips arranged in the pipette carrier are sealed against the sealing plate.

### BRIEF DESCRIPTION OF THE DRAWINGS

The present disclosure will now be explained in greater detail based on the appended drawing, the FIGS. 1-33 of which show as follows:

FIGS. 1-3 show a first embodiment of a double plate support of the present disclosure;

FIG. 4 shows a second embodiment of a double plate support of the present disclosure;

FIG. 5 shows a plan view of the upper plate of a double plate support of the present disclosure;

FIG. 6 shows a detail view of FIG. 5;

FIGS. 7-8 show an embodiment of a support system of the present disclosure;

FIG. 9 shows a sectional view of a support system of the present disclosure;

FIG. 10 shows another embodiment of a double plate support of the present disclosure;

FIG. 11 shows another embodiment of a support system of the present disclosure;

FIGS. 12-13 show an embodiment of an inventive single plate support;

FIGS. 14-15 show two other embodiments of an inventive single plate support;

FIGS. 16-17 show an embodiment of an inventive support arrangement;

FIG. 18 shows a first embodiment of a transfer device of the present disclosure;

FIG. 19 shows a second embodiment of a transfer device of the present disclosure;

FIG. 20 shows a first embodiment of a transfer system of the present disclosure;

FIGS. 21a, 21b, and 22 respectively show a third embodiment, a detail view of FIG. 21a, and a rotated view of the third embodiment of a transfer device of the present disclosure;

FIGS. 23a-c show a fourth embodiment and a detail view of a transfer device of the present disclosure;

FIG. 24 shows a fifth embodiment of a transfer device of the present disclosure;

FIGS. 25-27 show an embodiment of a transfer system of the invention with a single plate support;

FIGS. 28-29 show another embodiment of a transfer system of the present disclosure with a single plate support;

FIGS. 30-31 show an embodiment of a transfer system of the present disclosure with a double plate support; and

FIGS. 32-33 show two embodiments of a pipetting system of the present disclosure.

### DETAILED DESCRIPTION

The embodiments of the different apparatuses and devices described in the figures are combinable with one another to the extent desired. This holds for the examples of the transfer device of the present disclosure, whose numerous embodiments are shown based on a number of figures and whose embodiments can be combined to the extent desired.

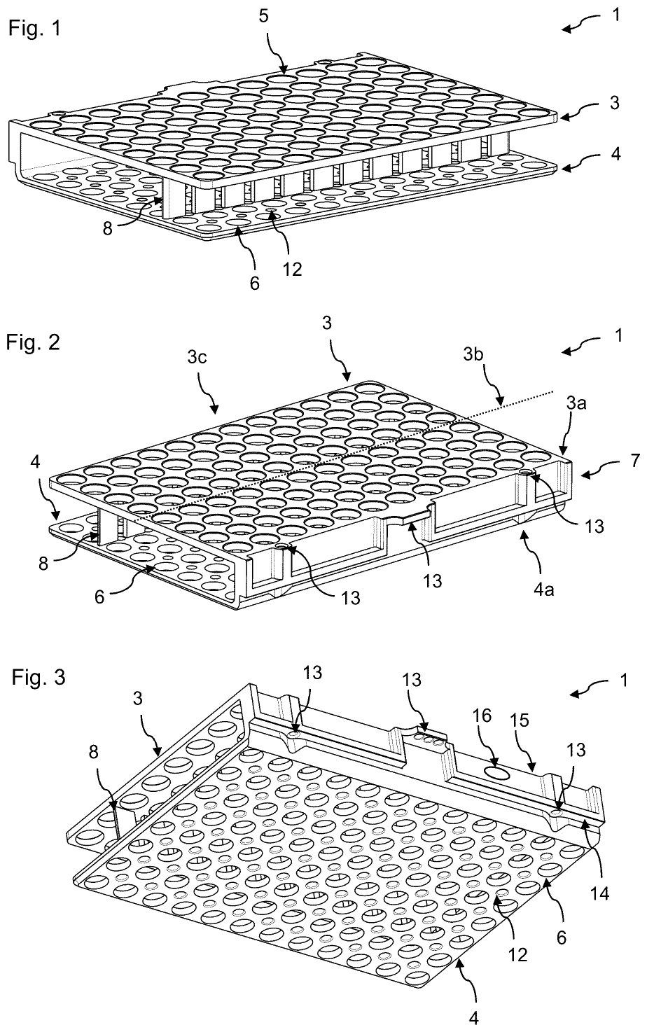

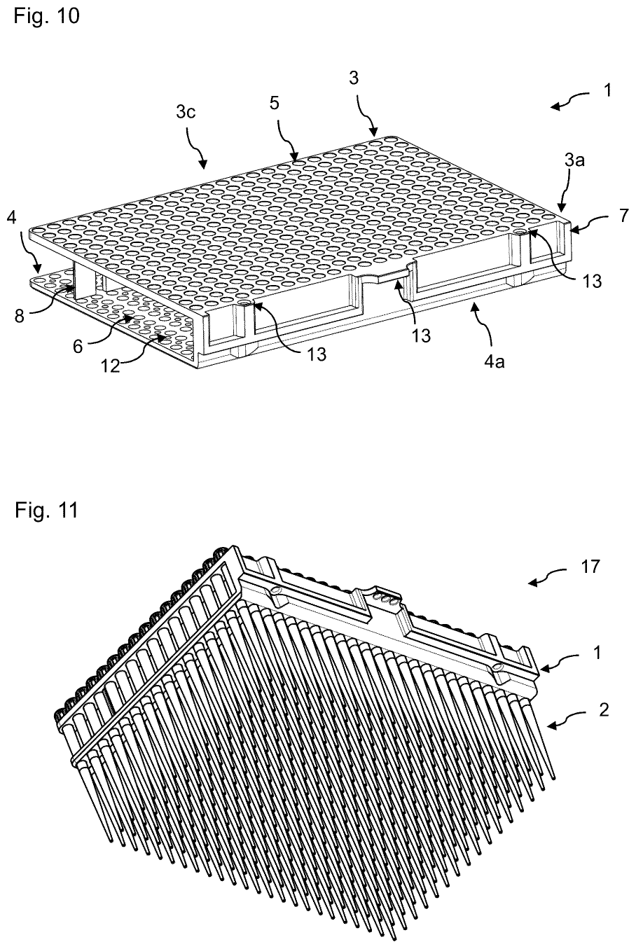

FIGS. 1-3 show, by way of example, a double plate support 1 in different views. Double plate support 1 includes an upper plate 3 and a lower plate 4, which are arranged essentially in parallel with one another and are embodied to be rigid. The upper plate 3 includes a plurality of first passageways 5 and the lower plate 4 includes a plurality of second passageways 6. The first passageways 5 and the second passageways 6 are embodied and arranged in such a manner that they align with one another. For example, the first passageways 5 and the second passageways 6 align with one another in such a manner that centers of the first passageways 5 and centers of aligning second passageways 6 are arranged on shared transverse axes 1a of the double plate support. In the sense of the present disclosure, a plurality of a component is meant to say that two or more components are present. For example, the number of first passageways 5 equals the number of second passageways 6. The numbers of first passageways 5 and second passageways 6 can equal the number of typical formats of microtiter plates and follow the established ANSI-SLAS standard. For example, the double plate support can have 96 or 384 first passageways 5 and 96 or 384 second passageways 6. An alternative form of embodiment of the double plate support 1 and the diameters of the first passageways 5 and the second passageways 6 is shown in FIG. 10. The first passageways 5 and the second passageways 6 can be circularly embodied, however, also have other forms, such as, for example, shown in FIG. 6. The diameters of the first passageways 5 and second passageways 6 can be the same; though, the diameters of the first passageways 5 and second passageways 6 deviate from one another, so that a diameter of the first passageways 5 is greater than a diameter of the second passageways 6. This follows from the common shape of pipette tips, which taper narrower from the collar 2c to the distal end region 2a. The upper plate 3 and the lower plate 4 are connected together by means of a side wall 7, which is arranged, in each case, along a first long side 3a, 4a of the upper plate 3 and the lower plate 4. Side wall 7 can extend over the entire length of the first long sides 3a, 3b or only over one or more sections of the first long sides 3a, 3b.

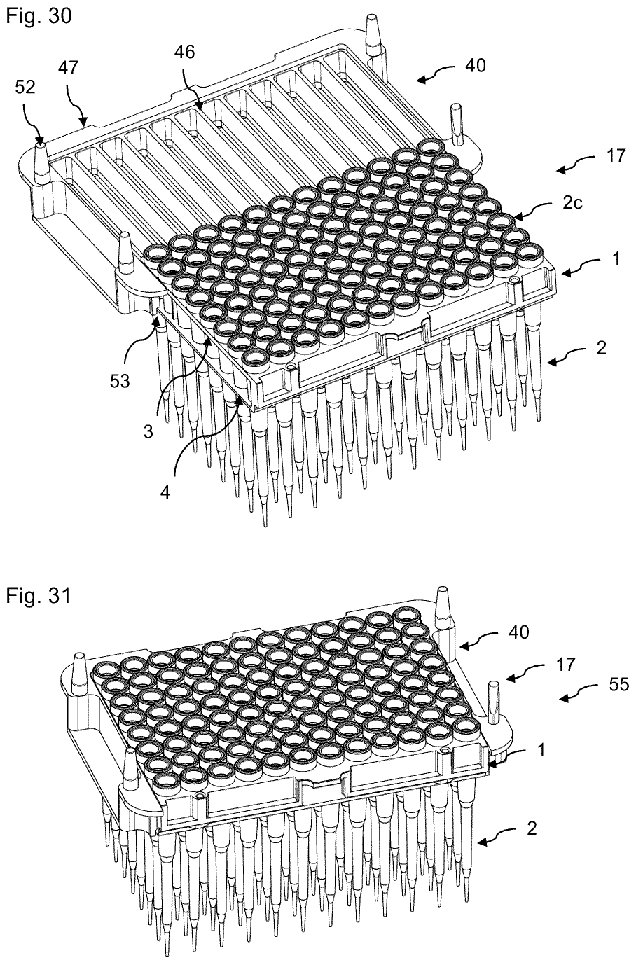

In order to assure stability of the double plate support 1, furthermore, a plurality of struts 8 are provided arranged between the upper plate 3 and the lower plate 4 and connecting the upper plate 3 and the lower plate 4 with one another. Struts 8 can be cylindrical, prismatic or conical, wherein also other embodiments are possible. Struts 8 can be arranged between a center 3b of the upper plate 3 and a second long side 3c of the upper plate 3 opposite the first long side 3a. Struts 8 can be arranged in symmetric or asymmetric patterns between the upper plate 3 and the lower plate 4. For example, struts 8 can be arranged equidistantly relative to one another and/or on an axis in parallel with the first long side 3a of the upper plate 3. A distance between the struts 8 can be selected in such a manner that, after populating the double plate support 1 with pipette tips 2, a transfer device 40 can fit between the struts 8, and between the pipette tips 2, and hold the double plate support 1 (compare FIGS. 30-31).

For an easy and material reduced embodiment of the double plate support 1, material reductions 12 can be engineered into the lower plate 4 and/or the upper plate 3. The material reductions 12 are intended to reduce the material usage for the lower plate 4 and/or the upper plate 3. The material reductions 12 can be embodied, for example, as recesses, holes or openings. In such case, the material reductions 12 are arranged between the second passageways 6 and/or the first passageways 5. The material reductions 12 do not align with the first passageways 5, or the second passageways 6. In the examples of FIGS. 1-4, the material reductions 12 are embodied as third passageways of the lower plate 4.

The side wall 7 can have other functions besides connecting the upper plate 3 with the lower plate 4. Thus, the side wall 7 can have one or more grip elements 13, which are arranged on a struts 8 far side area of the side wall 7 and embodied in such a manner that the double plate support 1 is holdable with automated means by means of the one or more grip elements 13. For example, the one or more grip elements 13 are embodied as object holders. FIGS. 2-3 show, by way of example, three grip elements 13, wherein the middle grip element is a flat plate and the two outer grip elements are object holders embodied as passageways. Such grip elements 13 can be gripped easily with conventional robots, for example, Cartesian robots, so that the double plate support 1 is holdable and transportable by means of the grip elements 13 using automated means.

Side wall 7 can have, furthermore, a code region 15 having at least one code element 16, based on which the double plate support 1 is identifiable. For example, it can be detected by means of the at least one code element 16 how many first and second passageways 5,6 the double plate support 1 has. The at least one code element 16 can be, for example, a QR-code, a barcode, an RFID-Tag or some other writing. Side wall 7 can have, additionally, at least one force input element 14, such as, for example, an edge, a projection, a ledge and/or a surface, by means of which force is exertable on the double plate support 1. The force can be exerted by a pipetting apparatus, after the double plate support 1 is placed in the pipetting apparatus. The force can serve to press the double plate support 1 against a sealing plate of the pipetting apparatus, in order to seal the pipette tips 2 against the sealing plate. The force is exerted on the force input element 14 in a direction from the lower plate 4 to the upper plate 3.

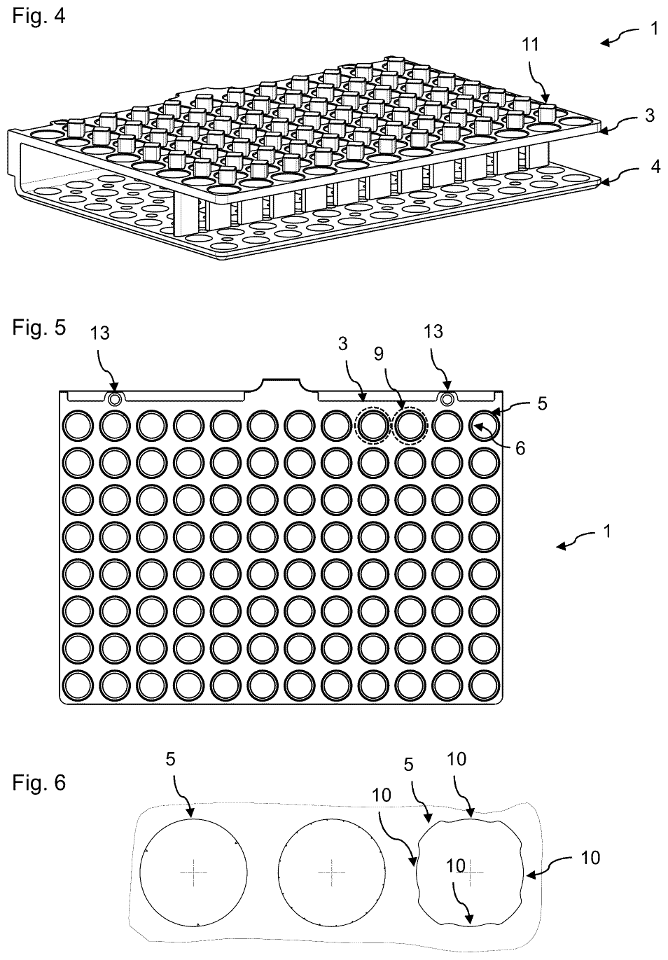

In order to prevent a tipping of the double plate support 1 in a pipetting apparatus 42 in the case of incomplete populating with pipette tips 2, at least one spacer 11 can be arranged on a lower plate 4 far area of the upper plate 3. The at least one spacer 11 can be cylindrical, conical or prismatic. For example, the upper plate 3 has a plurality of spacers 11, such as shown, by way of example, in FIG. 4.

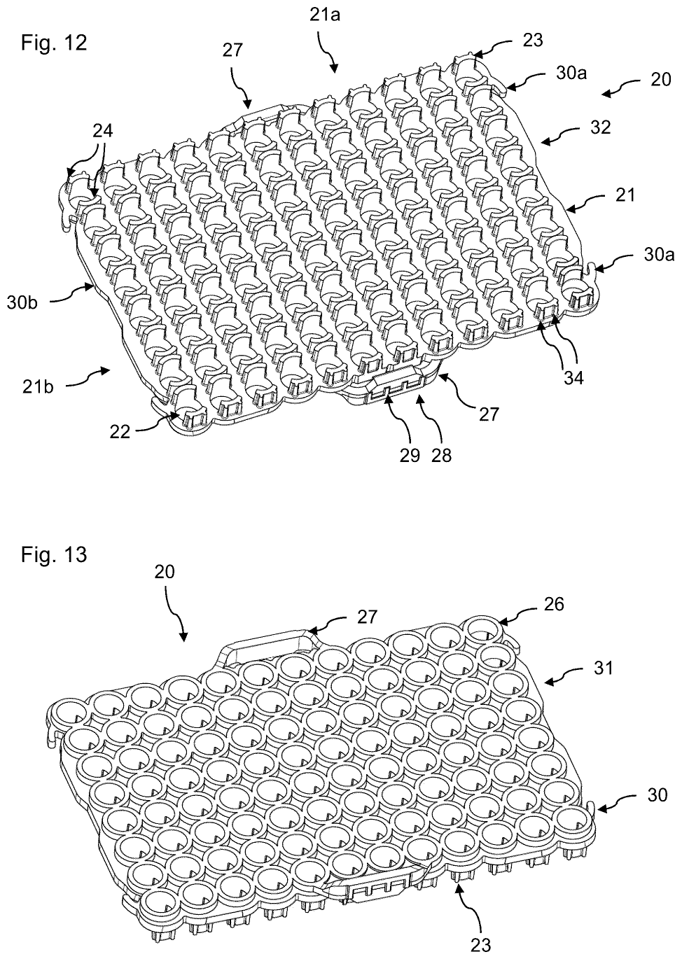

FIG. 5 shows a plan view of an upper plate 3 of a double plate support 1 of the present disclosure. Visible within the first passageways 5 are the second passageways 6 in the lower plate 4, which in this example have a smaller diameter than the first passageways 5. The first passageways 5 can be embodied in such a manner that a border 9 (shown dashed) of the first passageways 5 serves as support surface for collars 2c of inserted pipette tips 2. Alternatively, the upper plate 3 can have a plurality of support elements, which serve as support surface for a collar 2c of the pipette tips 2. An example of such a support element 26 is shown in FIG. 13 using the example of the single plate support 20 and can also be used in the case of the double plate support 1. The first passageways 5 and/or the second passageways 6 can be embodied circularly or have at least two radial segments 10. FIG. 6 shows this embodiment in detail. For example, the first passageways 5 and/or the second passageways 6 have two or four radial segments 10. For example, the first passageways 5 and the second passageways 6 are embodied in such a manner that pipette tips introduced into the first passageways 5 and the second passageways 6 are held in a predetermined position in the first passageways 5 and second passageways 6. Arranged on the upper plate 3 and/or the lower plate 4 can be at least one locking element 30. Examples of such locking elements are shown in FIG. 12 using the example of the single plate support 20; the illustrated locking elements 30 are applicable also for the double plate support 1. For example, the at least one locking element 30 is arranged on the upper plate 3, for example, on a transverse side of the upper plate 3. In this way, the at least one locking element can lock with at least one holding element 48 of the transfer device, such as shown, for example, in FIG. 18 or FIG. 19.

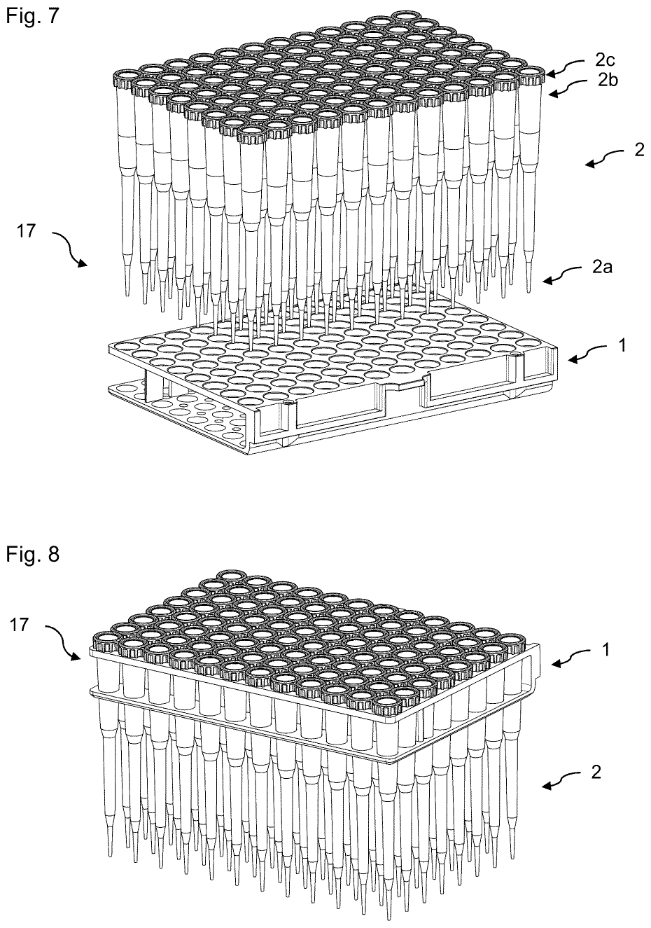

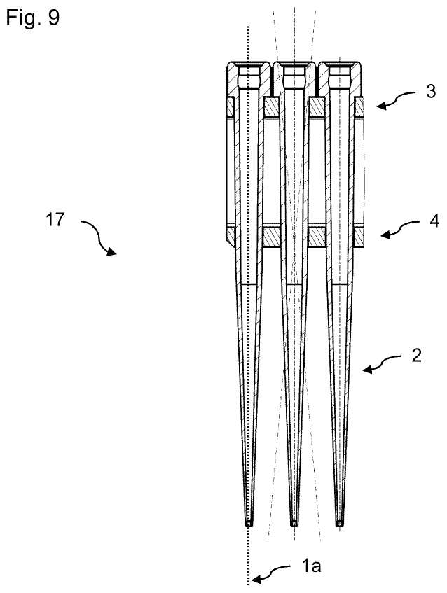

FIGS. 7-9 show a support system 17 of the present disclosure. Support system 17 includes a double plate support 1 and a plurality of pipette tips 2 having a proximal end 2a, a collar 2b and a distal end 2c and introduced into the first passageways 5 and the second passageways 6, such as shown in FIG. 8. FIG. 7 shows the support system 17 in exploded view. FIG. 9 shows a cross section through the support system 17. The first passageways 5 and the second passageways 6 can be embodied in such a manner that the pipette tips 2 are oriented along a transverse axis 1a of the double plate support 1. The transverse axis 1a of the double plate support 1 is, for example, transverse to the first long side 3a, 3b of the upper plate 3 and the lower plate 4. The number of pipette tips 2 can equal or be less than the number of first passageways 5.

FIG. 10 shows another embodiment of a double plate support 1. The first passageways 5 and the second passageways 6 are dimensioned in this variant less than in the preceding embodiments. Correspondingly, the double plate support 1 can hold significantly more pipette tips 2. FIG. 11 shows another embodiment of the support system 17 of the present disclosure using the double plate support 1 of FIG. 10.

FIGS. 12 and 13 show a single plate support 20 of the present disclosure schematically. Single plate support 20 comprises a plate 21 having an upper side 31, a lower side 32 and a plurality of openings 22. FIG. 12 shows a view of the lower side 32, while FIG. 13 shows a view of the upper side 31. Plate 21 is embodied to be rigid. Openings 22 are passageways. Openings 22 can be embodied, in each case, to hold a pipette tip 2. The number of openings 22 can be matched to the number of typical formats for microtiter plates and follow the established ANSI-SLAS standard. For example, the single plate support can have 96 or 384 openings 22. Arranged on the lower side 32 of the plate 21 are a plurality of orienting elements 23, which at least sectionally surround the openings 22. Orienting elements 23 can at least sectionally surround the openings 22, for example, along a periphery or edge of the openings 22. Orienting elements 23 are embodied to orient the pipette tips 2 placed in the openings 22 along transverse axes 20a of the single plate support 20. The transverse axes 20a of the single plate support 20 are transverse to the plate 21. Openings 22 and/or the orienting elements 23 can be embodied cylindrically or conically or have at least two radial segments 24. The at least two radial segments 24 can be arranged point- or mirror symmetrically. In the example of FIG. 12, the orienting elements 23 are embodied, in each case, in the form of two radial segments 24. It would also be possible to use, for example, three, four or more radial segments as orienting elements 23. Possible embodiments for the openings 22 can be taken from FIG. 6; in FIG. 6, the first passageways 5 correspond to the openings 22. Arranged on an openings 22 far surface of the orienting elements 23 can be reinforcing elements 34, such as, for example, ribs. A distance between the orienting elements 23 can be selected in such a manner that, after populating the single plate support 20 with pipette tips 2, a transfer device 40 can run in between the orienting elements and between the pipette tips 2, and hold the single plate support 20 (compare FIGS. 25-27).

Arranged on the upper side 31 can be, furthermore, a plurality of bearing elements 26, which serve as support surfaces for, in each case, a collar 2c of one of the pipette tips 2 provided in the openings 22. Bearing elements 26 can be embodied cylindrically or have at least two point- or mirror symmetrically arranged radial segments 24. By means of the bearing elements 26, it is prevented that the pipette tips 2 lie directly on the plate, which then would have to be built stronger. Bearing elements 26 at least partially surround the openings 22.

Single plate support 20 can have at least one grip 27, which is arranged on a long side 21a of the plate 21. For example, the single plate support 20 has two grips, which are arranged one on each of the long sides of the plate 21, such as shown in FIG. 12. The at least one grip 27 can have an identification region 28 having at least one identification element 29, based on which the single plate support 20 is identifiable. The at least one identification element 29 can be, for example, a QR-code, a barcode, an RFID-Tag or other writing.

Plate 21 can have at least one locking element 30, which is arranged on a transverse side 21b of the plate 21. The at least one locking element 30 serves for locking the single plate support 20 in a transfer device 40 along at least one axis. The at least one locking element 30 can be embodied as a catch, an indentation, a cavity and/or a ledge. FIGS. 12 and 13 show two different locking elements 30. Thus, arranged at each end of the transverse sides 21b of the plate 21 are a catch 30a and, centrally of the transverse sides 21b an indentation formed by two bulges 30b. The two catches 30a serve for locking the single plate support 20 in the plane of the plate 21, while the indentation serves for locking the single plate support 20 transversely to the plate 21.

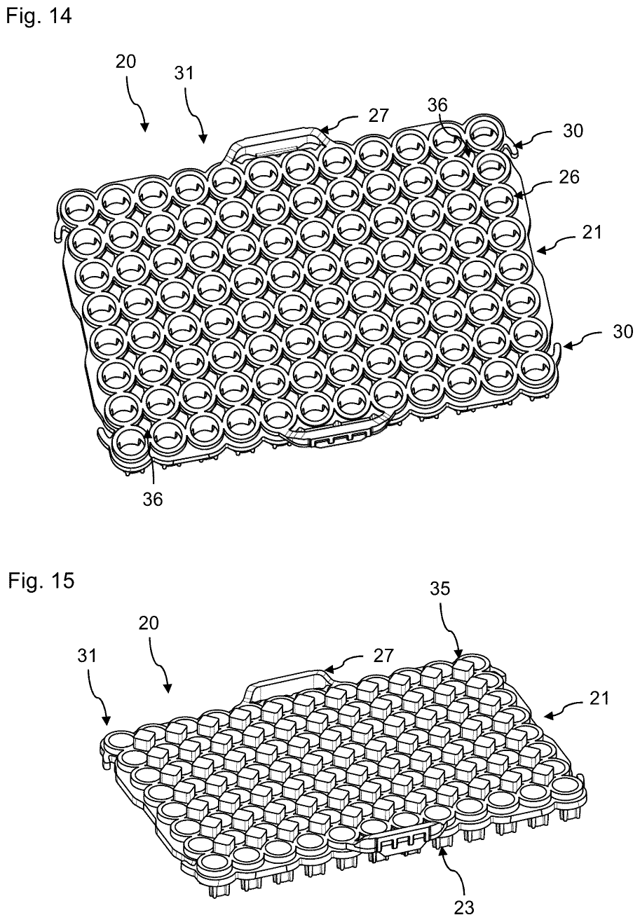

FIGS. 14 and 15 show two other embodiments of the single plate support 20 of the present disclosure. As shown in FIG. 14, the single plate support 20 can have a plurality of material reducers 36 in the form of e.g. depressions or holes on the plate 21. Such are arranged between the openings 22. As shown in FIG. 15, the single plate support 20 can have at least one spacer 35 on the upper side of the plate 21. The at least one spacer 35 is arranged between the openings 22.

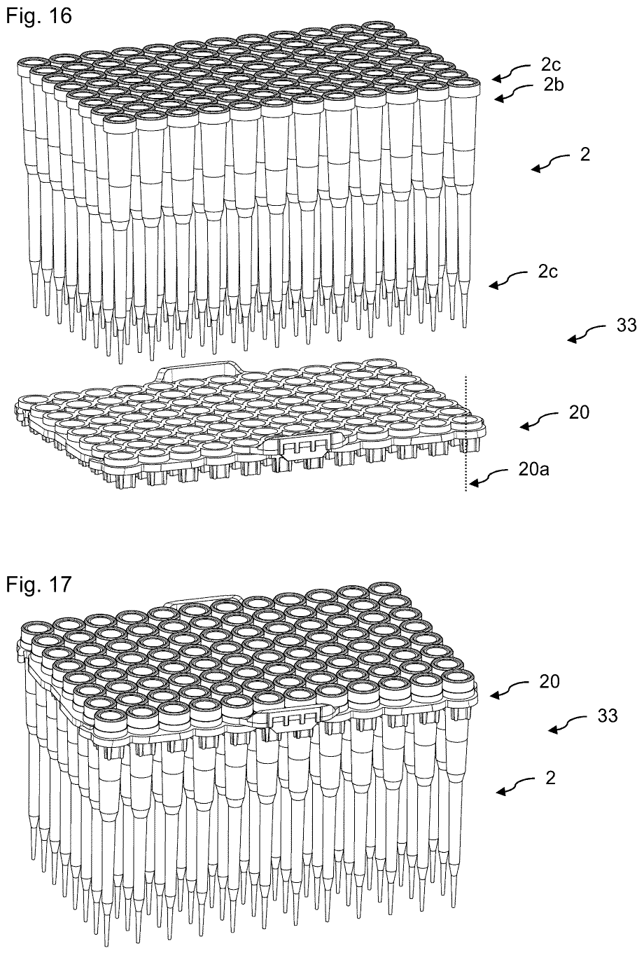

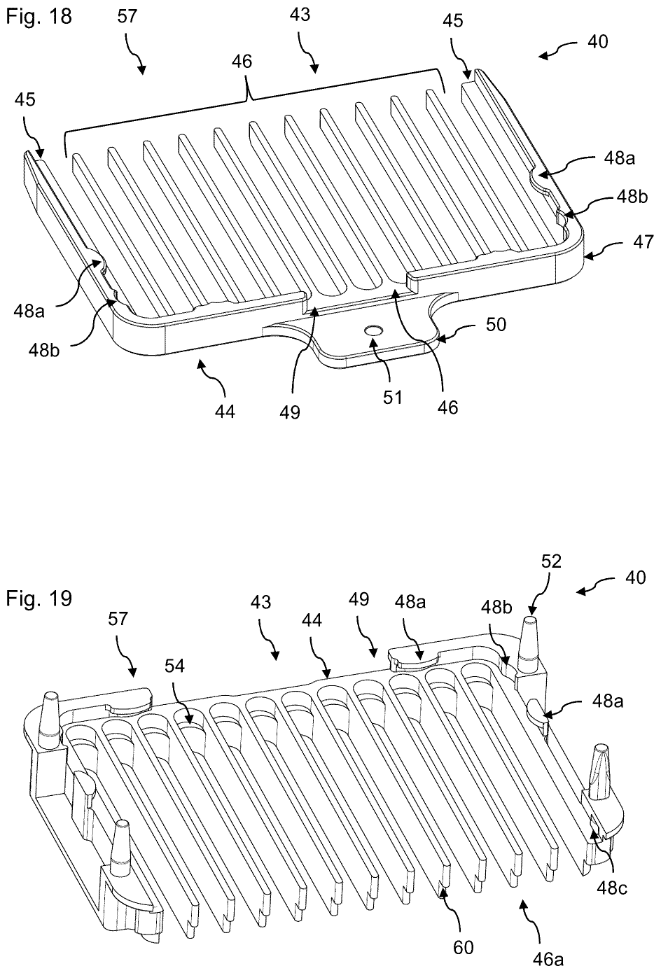

FIGS. 16 and 17 show a support arrangement 33 of the present disclosure comprising a single plate support 20 and a plurality of pipette tips 2, which are placed in the openings 22. FIG. 16 shows the support arrangement 33 in exploded view. Orienting elements 23 can be embodied to orient the pipette tips 2 in the openings 22, for example, to orient them along a transverse axis 20a of the single plate support 20. The number of pipette tips 2 can equal or be less than the number of openings 22.

FIG. 18 shows a first embodiment of a transfer device 40 of the present disclosure. The transfer device 40 has a comb structure 43 having an elongated base 44 and a plurality of perpendicularly arranged teeth 45, 46, which are arranged parallel and equidistantly relative to one another. Teeth 45, 46 comprise two outer teeth 45, which together with the elongated base 44 form a three sided frame 47. Arranged between the outer teeth 45 are a plurality of inner teeth 46. The inner teeth 46 can serve to hold a pipette carrier 41. The comb structure 43 can have an upper side 57 and a lower side 58. Additionally, the transfer device 40 can have at least one holding element 48 arranged on the frame 47 and embodied in such a manner that the pipette carrier 41 is lockable in the transfer device 40 along at least one axis. The at least one holding element 48 is, for example, embodied as an eave, a recess, a projection and/or an indentation. Shown in FIG. 18, by way of example, are two types of holding elements 48: an eave 48a and an indentation 48b. The eave 48a serves to lock the pipette carrier 41 in the transfer device 40 along an axis transverse to the frame 47. The indentation 48b serves for locking the pipette carrier 41 in the plane of the frame 47. The at least one holding element 48 can be embodied as a radial segment or circular segment. For example, the eave 48b is embodied as a circular segment. Alternatively, the at least one holding element 48 can have a spring, a magnet and/or a rotary element. FIG. 19 shows a holding element 48 embodied as a radial segment 48c.

Transfer device 40 can have a handle 50 arranged on the elongated base 44 and, for example, having a centering element 51, which is embodied in such a manner that the transfer device 40 can be moved using automated means. FIG. 18 shows the centering element 51 embodied, by way of example, as an opening. By means of the centering element 51, a robot can grip and move the transfer device 40. Also, an operator can hold and transport the transfer device 40 by means of the handle 50.

Frame 47 can have in the region of the elongated base 44 a frame depression 49 arranged, for example, centrally on the elongated base 44. Frame depression 49 can be embodied in such a manner that by the frame depression 49 the frame 47 falls to a height of the handle 50. The frame can further have at least one stop surface 54, which is arranged at least along the elongated base 44, and which is arranged at the same height of the frame 47 as the upper side of the inner teeth 46 or between the teeth 45, 46. The stop surface 54 serves for receiving the pipette carrier 41. The stop surface 54 can be arranged along the frame 47. In such case, the stop surface 54 can guide the pipette carrier 41 upon its introduction into the transfer device 40.

The inner teeth 46 can have on an elongated base far end 46a an engagement element 60, for example, an edge or a ledge. The engagement element 60 can be used for exerting a force on the transfer device 40, for example, by means of the pipetting apparatus 42. The force is, for example, exerted in the direction from the lower side 58 toward the upper side 57 of the inner teeth 46. FIG. 19 shows the engagement element 60 embodied as a ledge.

Transfer device 40 is suitable for pipetting apparatuses 42, which are embodied in such a manner that the transfer device 40 is brought, for example, plugged in, horizontally into the pipetting apparatus 42. Alternative pipetting apparatuses are embodied in such a way that the transfer device 40 is taken up vertically by the upper side 57 of the comb structure 43. For this, the transfer device 40 can have at least two orienting elements 52, such as shown in FIG. 19, which are embodied in such a manner that the transfer device 40 is introducible automatically into the pipetting apparatus 42. The pipetting apparatus 42 can have a pipetting head 72, which is movable along the z axis and so can be let down from above onto the transfer device and sit on the transfer device 40. The at least two orienting elements 52 serve, in such case, for guiding the pipetting head 72.

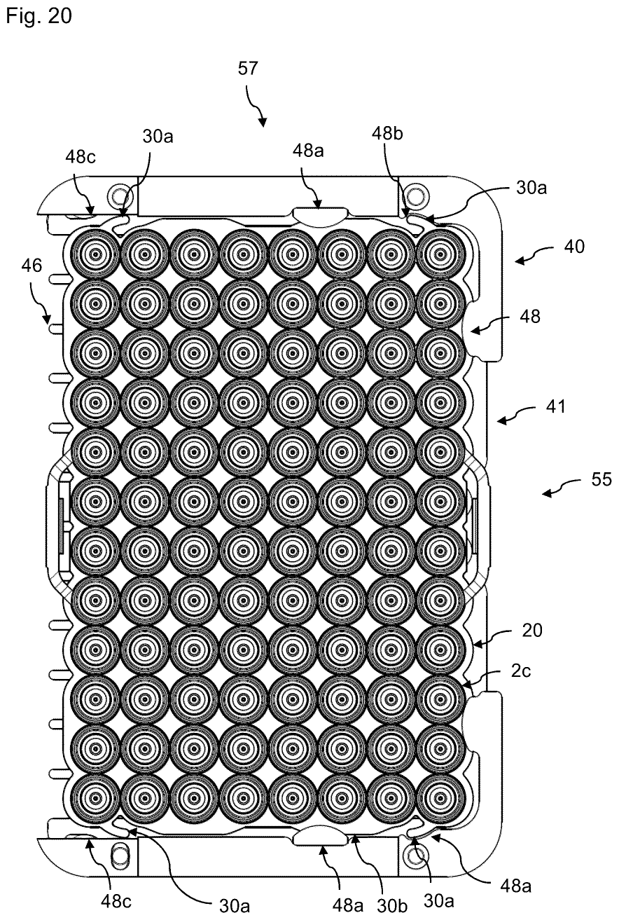

FIG. 20 shows an embodiment of a transfer system 55 of the present disclosure having a transfer device 40 and a pipette carrier 41 in a plan view of the upper side 57 of the comb structure 43. The transfer system 55 can comprise a plurality of pipette tips 2, which are introduced into the pipette carrier 41. The pipette carrier 41 shown in FIG. 20 is a single plate support 20; it can, however, also be a double plate support 1 or, in given cases, some other pipette carrier 41. The pipette carrier 41 can have at least one locking element 30 and the transfer device can have at least one holding element 48. The at least one holding element 48 and the at least one locking element 30 can be embodied in such a manner that a locking of the pipette carrier 41 and the transfer device 40 is achieved by means of a shape interlocking or a pinned assembly. The pipette carrier 41 can be locked in the transfer device 40 along at least one axis, in that a holding element 48 of the transfer device 40 engages with a locking element 30 of the pipette carrier 41. In the illustrated example, two catches 30a of the pipette carrier 41 each engage an indentation 48b of the transfer device 40, in order to prevent movement of the pipette carrier 41, thus a movement of the pipette carrier 41 along the elongated base 44. Two other catches 30a engage with two radial segments 48c, in order to prevent movement of the pipette carrier 41 in the direction of the teeth 45,46. Furthermore, two eaves 48a engage with indentations 30b, in order to prevent movement of the pipette carrier 41 transversely to the upper side 57.

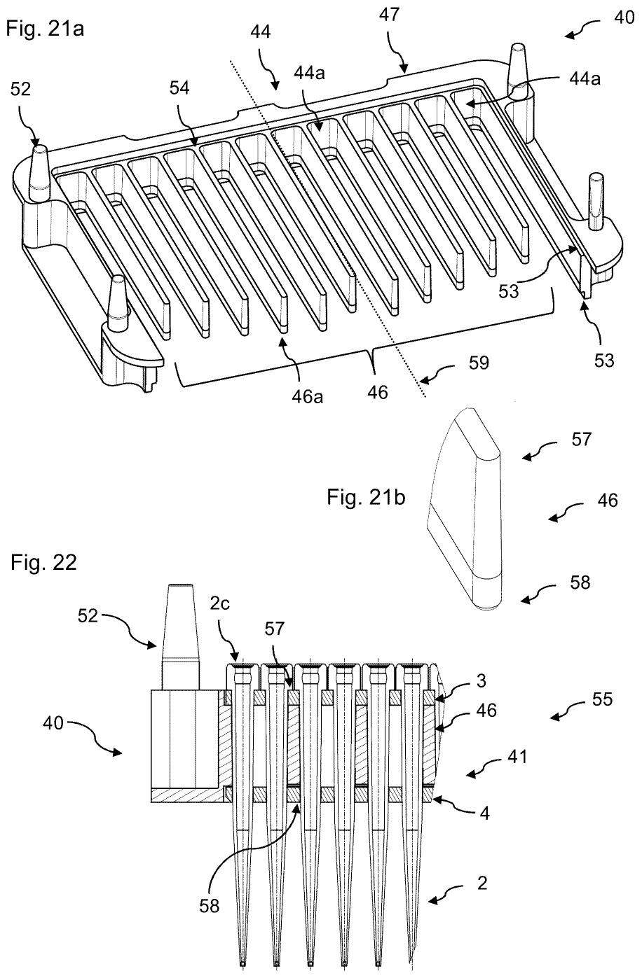

FIGS. 21a and 22 show another embodiment of the transfer device 40 of the present disclosure. The inner teeth 46 can have a tapered cross section tapering narrower in the direction of the upper side 57, in order to improve force transfer from the pipetting apparatus 42 to the transfer device 40. The inner teeth 46 can thus have a greater width on the lower side 58 than on the upper side 57. The tapering cross section of an inner tooth 46 is shown in detail in FIG. 21b. The tapering cross section can be embodied in the form of a trapezoid. The cross section can be embodied in such a manner that the cross section and an outer diameter of the pipette tips 2 are matched to one another over the entire length of the inner teeth 46.

The inner teeth 46 can be embodied in such a manner that at least one inner tooth 46 has a greater length than at least one other inner tooth 46. This facilitates the loading of the pipette carrier 41 into the transfer device 40, since the pipette carrier 41 engages, firstly, with the at least one inner tooth 46 with the greater length and in such a way can be led, in simple manner, between the other inner teeth 46. For example, the inner teeth 46 can be progressively longer from the outer teeth 45 to a middle 59 of the comb structure 43. Another option is that one or two inner teeth 46 centrally 59 of the comb structure 43 are shorter than the surrounding teeth 46. One or two inner teeth 46 can also be longer than the remaining inner teeth 46.

Considered length d of the inner teeth 46 can be a distance between a surface 44a of the elongated base 44, on which the inner teeth 46 are arranged, and an end 46a of the inner teeth 46 opposite the elongated base 44. The surface 44a of the elongated base 44, on which the inner teeth 46 are arranged, is, in such case, planar, such that the points of attachment of the inner teeth 46 on the elongated base 44 lie on a shared axis.

As already explained, at least one stop surface 54 can be provided, in order to guide the pipette carrier 41 upon its introduction into the transfer device 40. Frame 47 can have, furthermore, at least one peripheral guide groove 53. Guide groove 53 can likewise facilitate the loading of the pipette carrier 41. This holds in the case of a double plate support 1, in the case of which the lower plate 4 moves in the guide groove 53 on the lower side 58, the upper plate 4 moves in a guide groove 53 on the upper side 57 and the double plate support 1 can be loaded, thus, in simple manner, into the transfer device 40. In combination with the stop surface 54, the at least one guide groove 53 can further facilitate the loading of the pipette carrier 41.

FIG. 22 shows a cross section of a transfer system 55 having a transfer device 40 and a pipette carrier 41. The inner teeth 46 can have a tapering cross section. The pipette carrier 41 is optionally populated with pipette tips 2. The pipette carrier 41 is, by way of example, embodied as a double plate support 1 with an upper plate 3 and a lower plate 4; it can, however, also be embodied as a single plate support 1. Clear from FIG. 22 is that the tapered cross section of the inner teeth 46 is matched over the entire height of the teeth 46 to the, over the height changing, outer diameter of the pipette tips. A force exerted by means of a pipetting apparatus 42 on the transfer device 40 in the direction of the upper side 57 is transferred by means of the tapering section advantageously to the upper side 57 and the collars 2c of the pipette tips 2. This facilitates a sealing of the collars 2c against a sealing plate of the pipetting apparatus 42.

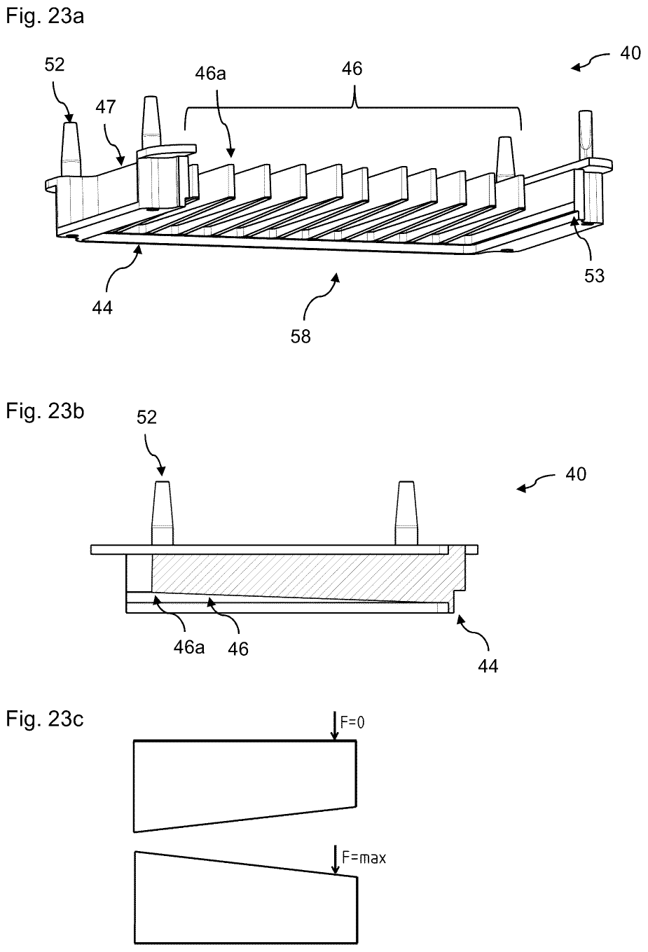

FIGS. 23a-c show another embodiment and detail of the transfer device 40 of the present disclosure. The inner teeth 46 can be reduced on the lower side 58 in such a manner that a height of the inner teeth 46 gets progressively smaller from the elongated base 44 to an elongated base 44 far end 46a of the inner teeth 46 reduces. FIG. 23b shows a cross section of the transfer device 40 illustrating the height reduction of the inner teeth 46 schematically. The height reduction of the inner teeth 46 facilitates a force input by the pipetting apparatus 42 exerted from the lower side 58 of the transfer device 40. For example, the inner teeth 46 can be reduced in height in such a manner that the height of the inner teeth 46 lessens with an angle between 0.05° and 6°, for example, between 0.05° and 3°. FIG. 23c shows schematically the effect of the height reduction of the inner teeth 46. Without force on the inner teeth 46, and thus on the transfer device 40, the inner teeth 46 show the height reduction, such as described. In the case of force, for example, from the pipetting apparatus 42, a deformation of the inner teeth 46 results, in such a manner that the lower side 58 of the inner teeth 46 approximates or reaches a horizontal position. The force on the transfer device 40 in the pipetting apparatus 42 can be exerted in the direction of the upper side 57, so that the transfer device is pressed against an area of the pipetting apparatus 42, for example, a sealing plate. The inner teeth 46 can serve for the force transfer from the pipetting apparatus 42 to the pipette carrier 41. The pipette carrier can be a single use article, which has greater manufacturing tolerances than the transfer device 40. The height reduction of the inner teeth 46 assures, thus, a compensating of the manufacturing tolerances of the pipette carrier 41 and can mean that a sealing plate 72 of the pipetting apparatus 42 is not damaged by the pipette carrier 41 in the case of exertion of the force on the transfer device 40.

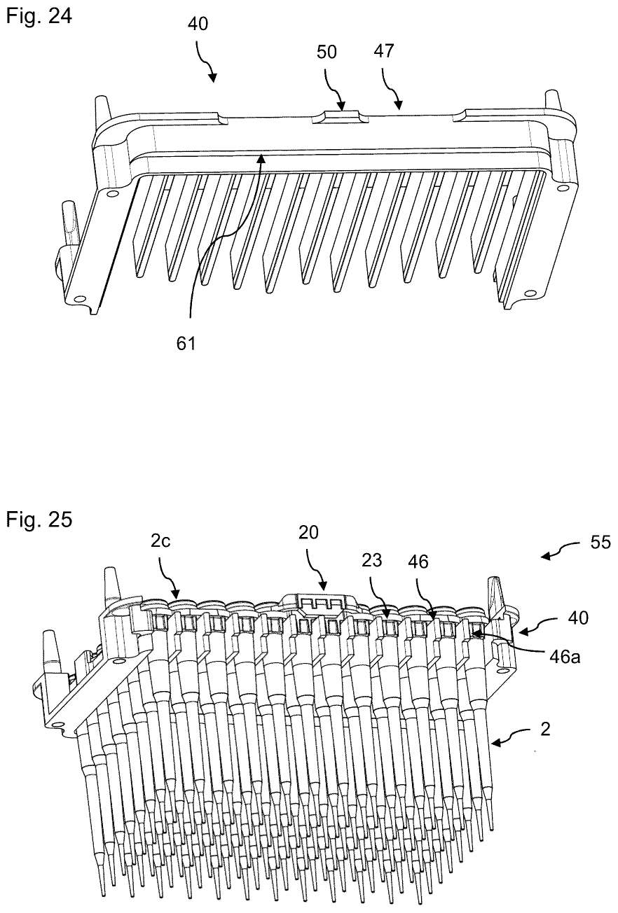

FIG. 24 shows another embodiment of the transfer device 40 of the present disclosure. Transfer device 40 can have on the frame 47 a gripping element 61, such as, for example, a ledge, an edge or a surface, by means of which a force can be exerted on the transfer device 40. In the illustrated example, the gripping element 61 is embodied as a surface.

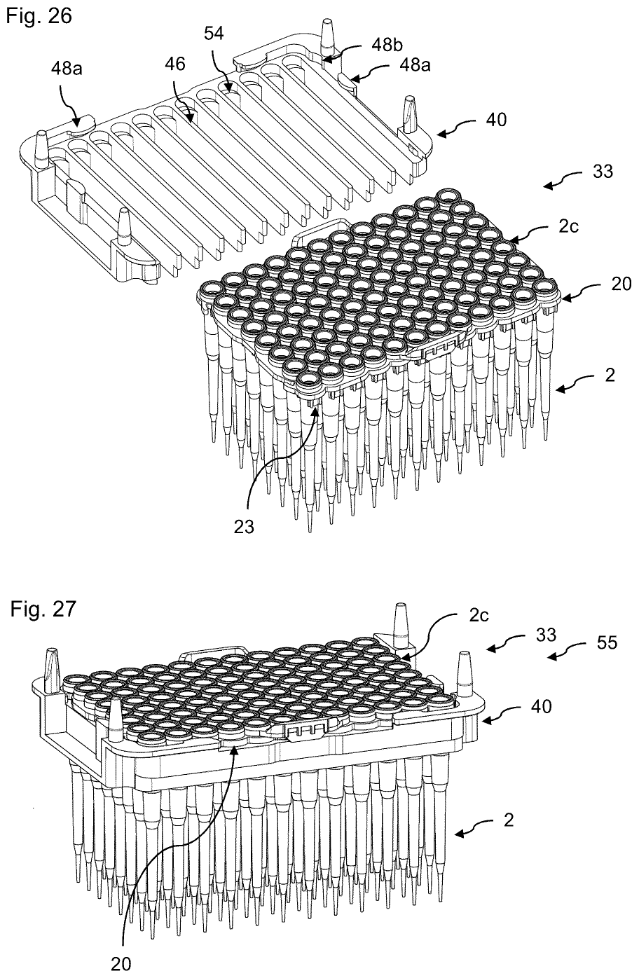

FIGS. 25-27 show an embodiment of a transfer system 55 of the present disclosure having a transfer device 40 and a single plate support 20. The transfer system 55 includes optionally a plurality of pipette tips 2, which are placed in the openings 22. FIG. 26 shows an exploded view of the transfer system 55, in which the transfer device 40 and the single plate support 20 are already oriented for holding the single plate support 20 by the transfer device 40. In FIGS. 27 and 25, the support arrangement 33 is completely loaded into the transfer device 40. Single plate support 20 can be loaded into the transfer device 40 in such a manner that the inner teeth 46 are arranged between the orienting elements 23. FIG. 25 shows a view of the transfer system 55 onto the ends 46a of the teeth. The inner teeth 46 can protrude out beyond the pipette tips 2. For example, when the inner teeth 46 are so embodied that at least one inner tooth 46 is longer than at least one other inner tooth 46, the at least one other inner tooth 46 can also end before the last position of the pipette tips 2.

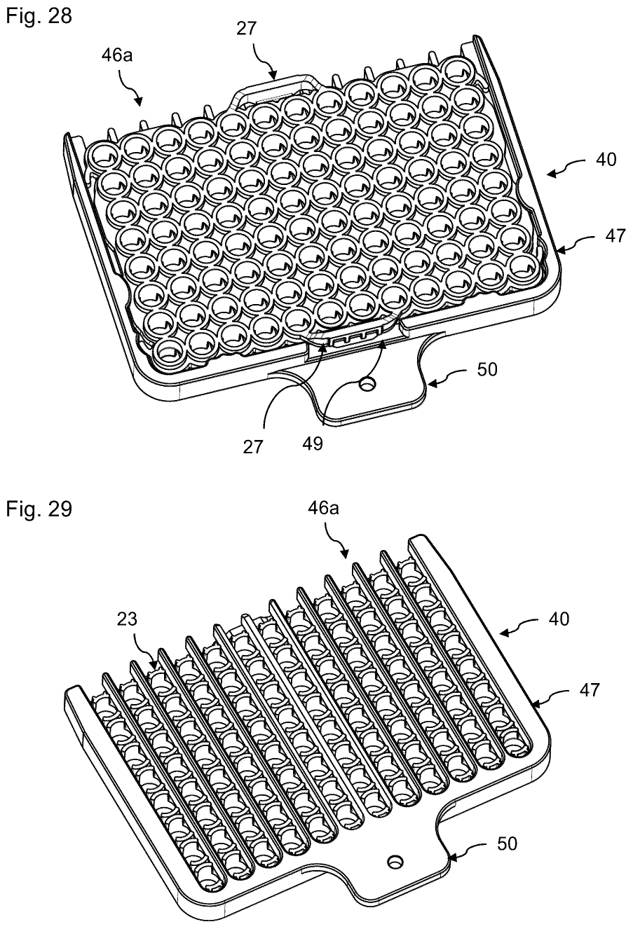

FIGS. 28-29 show another embodiment of a transfer system 55 of the present disclosure having a transfer device 40 and a single plate support 20. The at least one grip 27 can be arranged in such a manner that it is introduced into the frame depression 49. By means of an exertion of force on the at least one grip 27, or on the two grips 27, the single plate support 20 can be released from the transfer device 40.

FIGS. 30-31 show an embodiment of a transfer system 55 of the present disclosure having a transfer device 40 and a double plate support 1. Optionally, the transfer system 55 has a plurality of pipette tips 2, which are introduced into the first passageways 5 and the second passageways 6. FIG. 30 shows how the support system 17 is introduced into the transfer device 40, while in FIG. 31 the support system 17 is completely in the transfer device 40. In such case, the double plate support 1 can be introduced into the transfer device in such a manner that the inner teeth 46 are arranged between the upper plate 3 and the lower plate 4. The inner teeth 46 can protrude out beyond the pipette tips 2. For example, when the inner teeth 46 are so embodied that at least one inner tooth 46 is longer than at least one other inner tooth 46, the at least one other inner tooth 46 can also end before the last position of the pipette tips 2 (compare FIG. 25).

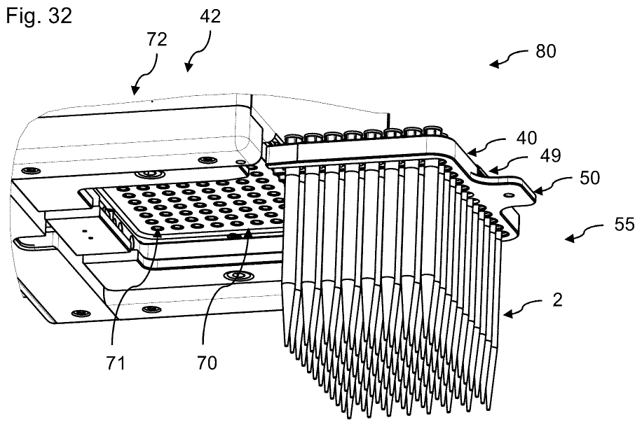

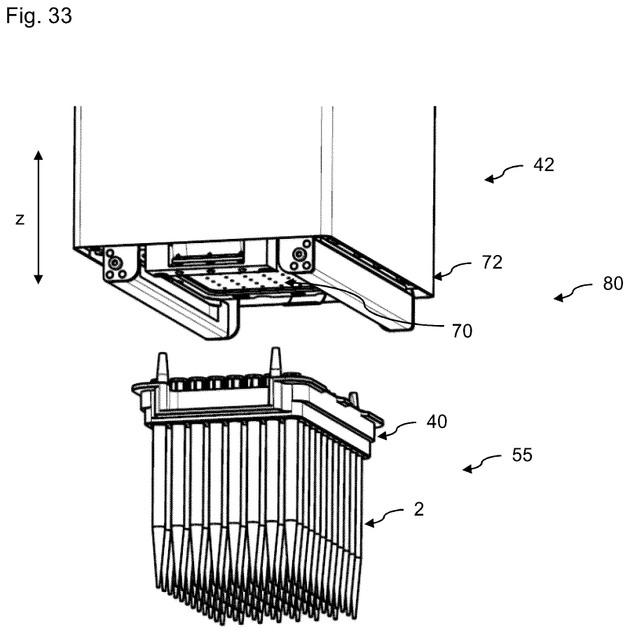

FIGS. 32-33 show two embodiments of a pipetting system 80 of the present disclosure. The pipetting system 80 includes a pipetting apparatus 42 and a transfer system 55, which in turn comprises a transfer device 40, a pipette carrier 41 and a plurality of pipette tips 2. The pipetting apparatus 42 can have a pipetting head 72, in which pipetting channels 71 are arranged for bringing and releasing of liquids into and from the pipette tips 2, and a sealing plate 70, wherein the pipetting channels are led through the sealing plate 70. The sealing plate 70 serves for sealing the pipette tips 2. The pipetting apparatus 42 can be adapted to exert a force on the transfer device 40, in such a manner that the pipette tips 2 arranged with their collars 2c in the pipette carrier 41 are sealed against the sealing plate 70. FIG. 32 shows the transfer system 55 being brought horizontally into the pipetting apparatus 42, while in FIG. 33 it is introduced vertically. For supporting the vertical introduction of the transfer system 55, at least two, possibly four, orienting elements 52 can be arranged on the pipette carrier 41. Regarding construction of the pipetting apparatus, particularly the pipetting head, for example, concerning the arrangement and embodiment of the pipetting channels and the sealing plate, comprehensive reference is taken to the utility model DE 20 2008 013 533 U1.

In the following, it will now be described, how the pipette carrier 41 is introduced into the transfer device 40 and how the so formed transfer system 55 is introduced into the pipetting apparatus 42. Then, it will be described, how, firstly, the transfer system 55 can be removed from the pipetting apparatus 42 and, finally, how the pipette carrier 41 can be removed from the transfer system 55.

A method for introducing a pipette carrier 41, for example, a double plate support 1 or a single plate support 20, into a transfer device 40 can be described based on FIG. 20. In such case, first, the pipette carrier 41 is introduced into the transfer device 40. The pipette carrier 41 includes at least one locking element 30 and the transfer device 40 at least one holding element 48, wherein the at least one locking element 30 is embodied corresponding to the at least one holding element 48. In such case, a section of the pipette carrier 41 can lie on the inner teeth 46. For example, the inner teeth 46 enter between the upper plate 3 and the lower plate 4 of the double plate support 1 or between the orienting elements 23 of the single plate support 20. In such case, the upper plate 3 or the plate 21 can lie on the inner teeth 46 and, in given cases, be guided by means of at least one stop surface 54 and/or at least one guide groove 53. Then, the pipette carrier 41 is locked in the transfer device 40, in that a first force is exerted on the pipette carrier 41 in the direction of the elongated base 44, until the at least one holding element 48 engages with the at least one locking element 30.

The transfer system 55, composed in such a way, can then be manually, or with automation, introduced into the pipetting apparatus 42. In the case of a horizontal introduction into the pipetting apparatus 42, such as shown by way of example in FIG. 32, the transfer system 55 can be introduced by means of a handle 50 of the transfer device 40. For the automated introduction, additionally, a centering element 51 in the handle 50 can be used. In the case of a vertical introduction into the pipetting apparatus 42, such as, by way of example, shown in FIG. 33, the pipetting head 72 can be moved in the direction of the z axis, in order with the help of the orienting elements 52 to hold the transfer system 55.

In order to be able to perform a pipetting procedure, the pipette tips 2 must be sealed against the sealing plate 70. For this, a pulling force can be exerted by means of the pipetting apparatus 42, in each case, exerted on the two long sides of the transfer system 55, so that the transfer system 55 is pressed against the sealing plate 70. If the pipette carrier 41 is a double plate support 1, then the pulling force can be exerted on the gripping element 61 of the transfer device 40 and the force input element 14 of the double plate support 1. For this, the pipetting apparatus 42 can have corresponding bearing elements, which are pressed against the gripping element 61 and the force input element 14. If the pipette carrier 1 is a single plate support 20, then the pulling force can be exerted on the gripping element 61 of the transfer device 40 and the engagement element 60 the transfer device 40. Also, in this case, the pipetting apparatus 42 can have corresponding bearing elements, which are pressed against the gripping element 61 and the engagement element 60. The bearing elements can be arranged on pivotable arms.

After the sealing of the transfer system 55 in the pipetting apparatus 42, then a pipetting procedure can be performed. After termination of the pipetting procedure, the pulling force can be released and the transfer system 55 either discarded by means of the pipetting head 72 or released by means of the handle 50 from the pipetting apparatus 42.

In an additional step, the pipette carrier 41 can be removed from the transfer system 55. For this, the locking between the at least one locking element 30 and the at least one holding element 48 must be released. Such can happen, in that a second force is exerted on the pipette carrier 41 in the direction of a lower side 58 of the comb structure 43, so that the locking between the at least one holding element 48 and the at least one locking element 30 releases. The second force can be exerted manually or by automated means. In the case of a single plate support 20, the second force can be exerted on the at least one grip 27 of the single plate support 20. For example, the single plate support 20 has two grips 27 and the second force is exerted simultaneously on both. In the case of a double plate support 1, the second force can be exerted on the at least one grip element 13. Transfer device 40 can in both cases have a frame depression 49, into which the grip 27, or the grip element 13, protrudes inwardly, so that an operator or robot can easily reach and operate the grip 27, or the grip element 13.

Claimed is:

1. A transfer device for inserting a pipette carrier into a pipetting apparatus, comprising:
a comb structure having an elongated base and a plurality of teeth arranged perpendicularly thereto, wherein the teeth are arranged parallel and equidistantly relative to one another and include two outer teeth and a plurality of inner teeth arranged between the outer teeth, wherein the elongated base and the two outer teeth are embodied in the form of a three sided frame,
wherein at least one inner tooth has a greater length than at least one other inner tooth.

2. The transfer device as claimed in claim 1,
wherein the inner teeth become longer incrementally from the outer teeth to a middle of the comb structure.

3. The transfer device as claimed in claim 1,
wherein one or two inner teeth near a middle of the comb structure are shorter than the inner teeth surrounding the one or two inner teeth.

4. The transfer device as claimed in claim 1,
wherein one or two inner teeth are longer than other inner teeth.

5. The transfer device as claimed in claim 1,
wherein the transfer device includes at least one holding element arranged on the frame,
wherein the at least one holding element is embodied such that the pipette carrier is lockable in the transfer device along at least one axis.

6. The transfer device as claimed in claim 1,
wherein the transfer device includes a handle arranged on the elongated base.

7. The transfer device as claimed in claim 1,
wherein the frame includes a frame depression in a region of the elongated base.

8. The transfer device as claimed in claim 1,
wherein the frame includes at least one stop surface arranged at least along the elongated base,
wherein the at least one stop surface is arranged at a same height on the frame as the upper side of the inner teeth or is arranged between the teeth.

9. The transfer device as claimed in claim 1,
wherein each inner tooth has at one end of the inner tooth at least one engagement element configured to receive a force exerted on the transfer device.

10. The transfer device as claimed in claim 1,
wherein the frame includes a gripping element configured to receive a force exerted on the transfer device.

11. The transfer device as claimed in claim 1,
wherein the inner teeth have a tapered cross section that tapers in a direction of the upper side.

12. The transfer device as claimed in claim 1,
wherein the tapered cross section is embodied such that the tapered cross section conforms to an outer diameter of pipette tips over the entire height of the inner teeth.

13. The transfer device as claimed in claim 1,
wherein the inner teeth are reduced in height on the lower side such that a height of the inner teeth becomes progressively smaller from the elongated base to an end of the inner teeth.

14. A transfer system comprising:
a pipette carrier, and
a transfer device as claimed in claim 1,
wherein the pipette carrier is insertable into the transfer device.

15. A pipetting system comprising:
a transfer system as claimed in claim 14; and
a pipetting apparatus including a pipetting head,
wherein the pipetting head includes a sealing plate and a plurality of pipetting channels for uptake and dispensing of liquids into and from the pipette tips,
wherein the pipetting channels are led through the sealing plate;
wherein the transfer system is insertable into the pipetting apparatus, and
wherein the pipetting apparatus is configured to exert a force on the transfer device in such that pipette tips arranged in the pipette carrier are sealed against the sealing plate.

16. The transfer device as claimed in claim 7, wherein the frame depression is arranged centrally on the elongated base.

17. The transfer system of claim 14, wherein the pipette carrier is a double plate support or a single plate support.
